(19) United States
(12) Patent Application Publication
(10) Pub. No.: US 2016/0207797 A1
(43) Pub. Date: Jul. 21, 2016

(54) ION EXCHANGE RESIN REGENERATION METHOD

(71) Applicant: PUROLITE CORPORATION, Bala Cynwyd, PA (US)

(72) Inventor: Francis Boodoo, King of Prussia, PA (US)

(21) Appl. No.: 14/914,764

(22) PCT Filed: Aug. 19, 2014
(86) PCT No.: PCT/US14/51733

§ 371 Date: Feb. 26, 2016

Related U.S. Application Data
(60) Provisional application No. 61/870,647, filed on Aug. 27, 2013.

(51) Int. Cl. C02F 1/42; C05C 5/02; C05C 5/00; B01J 41/04; B01J 49/00

(52) U.S. Cl. CPC C02F 1/42; B01J 41/04; B01J 49/0073; C05C 5/00; C05C 5/02; C02F 2001/422; C02F 2101/163

(57) ABSTRACT

This application relates generally to a process for regeneration of anion exchange resins and more particularly to regeneration using inorganic fertilizer solutions (e.g., solutions of magnesium, calcium, potassium, and ammonium salts) to remove nitrate and other contaminants from the anion exchange resins.

### CROSS-REFERENCE TO RELATED APPLICATION

This application claims priority to U.S. Provisional Application No. 61/870,647, filed Aug. 27, 2013, the contents of which are hereby incorporated by reference in its entirety.

### FIELD OF THE INVENTION

This application relates generally to a process for regenerating anion exchange resins with substantially no liquid waste and more particularly to regeneration using inorganic fertilizer solutions (e.g., solutions of magnesium, calcium, potassium, and ammonium salts) to remove nitrate and other contaminants from the anion exchange resins.

### BACKGROUND OF THE INVENTION

The present invention relates to water treatment, particularly the treatment of waste water or ground water for environmental remediation, or for the production of higher grade water, for example, water that is useful for industrial, agricultural or potable use. The invention particularly addresses processes for removing anionic contaminants such as nitrate (NO₃⁻) ions, organic contaminants, and other contaminants from a water source. The nitrate or organic contaminants may be present in the source either alone or in combination with other contaminants or native impurities.

Nitrate ions present in drinking water systems present a serious health hazard to the general public. In particular, nitrate exposure can cause fatal methemoglobinemia in young children, and various nitrate byproducts (e.g., nitrosamines) can be carcinogenic at high concentrations. The U.S. Environmental Protection Agency has therefore established maximum contaminant levels of 10 milligrams per liter (mg/L) for nitrate (measured as nitrogen) and 1.0 mg/L nitrite (measured as nitrogen) in drinking water for public consumption. However, the high solubility of nitrates in aqueous media and the prevalence of nitrogen-based fertilizers and industrial discharges are gradually increasing the presence of nitrates in surface water and groundwater, making it more difficult to satisfy such regulatory limits.

Organic contaminants are sometimes referred to as total organic carbon (TOC) and/or natural organic matter. Non-limiting examples of TOCs include humic acids, fulvic acids, tannins, and other organic compounds formed by degradation of plant residues and/or by various industrial processes such as pulping and paper making. TOC removal is required for water intended for potable use in which oxidants are added before the water is distributed to consumers. Reaction between TOC present in water and oxidants can form disinfection byproducts (DBPs) at concentrations that exceed the maximum contaminant level (MCL) permitted by regulatory authorities. For example United States EPA regulations mandate reduction of TOC in water intended for potable use by at least 35%, depending on the alkalinity in the water.

Several technologies exist for the removal of nitrates and TOC contaminants from water. In particular, nitrates and TOC contaminants can be removed by passing ground water through one or more anion exchange resin beds. The nitrate ions and any other anionic contaminants can be captured on the exchange resins, producing purified water with reduced anionic content. Eventually, the resin beds reach capacity for capturing additional anions and the resin must be regenerated to remove captured anions and restore capacity to the resin for further treatment of water. When the exchange beds are periodically regenerated, the accumulated nitrate and TOC enters the regeneration waste fluids. Current practice is to regenerate the resin with high concentrations of sodium chloride (or brine) to elute the nitrate and/or TOC contaminants from the resin. Relatively large amounts of sodium chloride are typically used (e.g., a standard dosage of eight equivalents of sodium chloride is generally required to remove one equivalent of nitrate from the resin), creating large waste volumes that are difficult to dispose. Waste brine must either be hauled offsite for disposal at great expense, discharged to waste plants, or in evaporation ponds. Waste products may also be broken down in a bioreactor or composting process, or may be incinerated on-site. Tightening of environmental regulations is expected to further prohibit or limit existing disposal methods. Spent brine from a resin regeneration facility may also be discharged at sea, but it is widely expected that permits to continue such disposition may not be available in the future.

Accordingly, it is an object of the present invention to provide a method for efficiently and effectively reducing anionic contaminants (e.g., nitrate ions) and TOC and other contaminants from ground water rendering it safe for public consumption. It is a further object of the present invention to provide a method for reducing contaminants from ground water that is both effective and economical to practice and reduces and preferably eliminates the handling and disposal of large amounts of waste stream or solid waste residue.

### SUMMARY OF THE INVENTION

A new method of purifying feed water containing various contaminants (e.g., nitrate and TOC, etc.) with substantially no liquid waste is now provided.

One embodiment provides a method of purifying feed water containing contaminants comprising: (1) passing a volume of the feed water containing contaminants through an anion exchange resin to capture contaminants on the resin; (2) periodically regenerating the resin by passing a volume of a regenerant fertilizer solution including one or more inorganic salts through the resin to release contaminants from the resin into the regenerant fertilizer solution; (3) rinsing the resin of residual regenerant solution by passing a volume of a rinse solution through the resin; and (4) isolating the regenerant and rinse solution from the resin to provide an enhanced fertilizer solution.

In one embodiment, the rinse solution is feed water or purified feed water.

In one embodiment, the concentration of inorganic salts in the enhanced fertilizer solution is higher than the concentration of inorganic salts in the initial regenerant fertilizer solution.

The regenerant fertilizer solution may comprise salts such as magnesium sulfate (MgSO₄), potassium sulfate (K₂SO₄), ammonium sulfate ((NH₄)₂SO₄), magnesium bisulfate (MgHSO₄), potassium bisulfate (KHSO₄), ammonium bisulfate (NH₄HSO₃), magnesium carbonate (MgCO₃), potassium carbonate (K₂CO₃), ammonium carbonate ((NH₄)₂CO₃), magnesium bicarbonate (MgHCO₃), potassium bicarbonate (KHCO₃), ammonium bicarbonate, (NH₄HCO₃), potassium chloride (KCl), ammonium chloride (NH₄Cl), calcium chloride (CaCl₂), and magnesium chloride (MgCl₂), and combinations thereof. In one embodiment, the regenerant fertilizer solution comprises a plurality of inorganic fertilizers. The concentration of inorganic salts in the regenerant fertilizer solution may be in the range of about 0.001 to 50 weight %, or about 0.001 to about 2.5 weight %, or about 1 weight %.

The feed water may include, for example, ground water, surface water, agricultural field drainage, process feed water, process waste water, or any water containing contaminants. The contaminants in the feed water may include nitrate, arsenic, chromate, selenate, uranium, fluoride, bromide, sulfate, chloride, perchlorate, or organic contaminants, or combinations thereof. The concentration of contaminants in the feed water may be up to about 1000 ppm, more specifically about 10 to about 50 ppm.

In one embodiment, the anion exchange resin comprises a strong base anion exchange resin. This resin may be, for example, a gel-type resin containing quaternary ammonium functionality and a polystyrene matrix cross-linked with divinylbenzene (such as Purolite® A300E and Purolite® A600E/9149). Suitable anion exchange resins also include macroporous-type resins, anion exchange resin in a mixed base resin with strong and weak base functionalities, and resins containing aminated functional groups and a matrix of a cross-linked polymer containing a core area and a shell area, wherein the concentration of aminated functional groups is lower in the core area relative to the shell area (e.g., Purolite® SSTA63 and Purolite® SSTA64). The anion exchange resins may also include resins containing at least two or more functionally distinct polymer resin particles, wherein at least two functionally distinct polymer resin particles contain different anion exchange functional groups.

In one embodiment, the regeneration method reduces the concentration of anions bound to the resin by at least 20% or more (or at least about 50% or 95% or more). In one embodiment, the purification method reduces the concentration of anions in the feed water by at least about 50% or at least about 95% or more.

The regenerant solution may flow through the ion exchange component in the same direction as the flow of feed water or in a direction opposite from the flow of the feed water.

In another embodiment of the present invention, a process for preparing an enhanced fertilizer solution is provided. In one embodiment, the process comprises: (1) providing a feed water comprising contaminants; (2) passing a volume of the feed water containing contaminants through an anion exchange resin to capture contaminants on the resin; (3) periodically regenerating the resin by passing a volume of a regenerant fertilizer solution including one or more inorganic salts through the resin to release contaminants from the resin into the regenerant fertilizer solution; (4) rinsing the resin of residual regenerant solution by passing a volume of a rinse solution through the resin; and (5) isolating the regenerant and rinse solution from the resin to provide an enhanced fertilizer solution.

In some embodiments, the enhanced fertilizer composition is a crop fertilizer.

### BRIEF DESCRIPTION OF THE DRAWINGS

FIG. 1 schematically depicts a water treatment system of the present invention.

FIG. 2 schematically depicts a water treatment system of the present invention.

FIG. 3 is a flow diagram illustrating certain embodiments of the invention.

### DETAILED DESCRIPTION

The present invention addresses processes for removal of contaminants (e.g., nitrate, arsenic, chromate, selenate, uranium, fluoride, bromide, sulfate, chloride and/or organic contaminants) from a water source. This invention makes use of commercial fertilizers (e.g., solutions of inorganic salts such as divalent sulfate and carbonate salts of magnesium, potassium, and ammonium) in the regeneration of strong base anion exchange resins, allowing operators of ion exchange water purification systems to:
(a) reduce and preferably eliminate the disposal costs for waste regenerant and rinses for regenerating anion exchange resins used for purifying contaminants from feed water;
(b) minimize and preferably eliminate burden on the environment associated with the discharge of high quantities of sodium chloride;
(c) recover fertilizer used for regeneration for subsequent use as a crop fertilizer and/or other beneficial purposes; and/or
(d) achieve low levels of contaminants (e.g., nitrate, arsenic, chromate, selenate, uranium, fluoride, bromide, sulfate, chloride and/or organic contaminants) previously considered unattainable for dilute salt regenerated resins.

This invention relates to “zero-liquid waste” process which allows for the recovery and reuse of substantially the entire quantity of the fertilizer regenerant, eliminating liquid discharge operation of the ion exchange plant. The spent regenerant, rinse water used for subsequent rinsing of the resin, and any water used for backwashing of the resin, are recovered and isolated as a nutrient-enhanced crop fertilizer. This eliminates the high disposal costs of spent regenerant and provides a sustainable “green” process whereby a fertilizer can be reused for crop growing. The crop grower can negotiate pricing and buy enhanced fertilizers from the Water Treatment Plant (WTP) containing other beneficial secondary nutrients added as needed (e.g., magnesium, calcium, sulfate, chloride). The fertilizer can be tailored to meet specific agricultural needs by selecting inorganic salts that are needed for a desired application.

In general, the present process is applicable to the removal of contaminants from water streams containing the contaminants. It is particularly effective for the treatment of inland water as well as water that is readily transportable to an ocean, sea or other large salt water body for disposal. As defined herein, the term “feed water” will designate the water streams to be treated by the present process. Such feed waters include ground water, surface water, waste waters, including agricultural and field drainage and urban waste water, and aqueous waste from the operation of evaporative cooling towers and certain processes of industry and energy conversion. The term feed water also includes water which has undergone prior processing, e.g., chemical precipitation softening, coagulation, clarification, sand filtration, multi-media filtration, activated carbon filtration, degasification, ion exchange softening, dealkalization, electrocoagulation, ultrafiltration, microfiltration, reverse osmosis, forward osmosis or electrodialysis, before the treatment of the present invention.

In general, the feed water streams to which the present invention is applicable include a variety of contaminants. Non-limiting examples of anionic contaminants commonly found in water include nitrate (NO₃⁻), perchlorate (ClO₄⁻), bicarbonate (HCO₃⁻), sulfate (SO₄²⁻), pertechnetate (TcO₄⁻), chromate (CrO₄²⁻), bromate (BrO₃⁻), arsenate (AsO₄³⁻), selenate (SeO₄), titanate (e.g., TiO₄²⁻, [TiCl₆]²⁻ and [Ti(CO)₇]²), bromide (Br⁻), chloride (Cl⁻), nitrite (NO₂⁻), oxalate (C₂O₄²⁻), chlorate (ClO₃⁻), fluoride (F⁻), formate (HCO₂⁻), phosphate (PO₄³⁻), and other anionic contaminants formed by degradation of plant residues (e g humic, fulvic and tannic acids) and/or by various industrial processes. In some preferred embodiments of the invention, the anionic contaminants are nitrate contaminants. In other preferred embodiments, the anionic contaminants are perchlorate contaminants. In other preferred embodiments of the invention, the contaminants are organic contaminants, commonly expressed as total organic carbon (TOC), dissolved organic carbon (DOC), and naturally occurring organic matter (NOM). In other embodiments of the invention, the contaminants include arsenic, chromate, selenate, uranium, fluoride, bromide, sulfate, chloride or organic contaminants.

Excessive nitrate or nitrite in drinking water is a health concern for infants (through 6 months of age) and for women during pregnancy. The U.S. Environmental Protection Agency has established maximum contaminant levels of 10 milligrams per liter (mg/L) for nitrate (measured as nitrogen) and 1.0 mg/L for nitrite (measured as nitrogen). Nitrate is a component in fertilizer, and both nitrate and nitrite are found in sewage and sanitary wastes from humans and animals. Certain construction activities, such as blasting, can be another source of nitrate in bedrock wells. Nitrate or nitrite levels can also become elevated when the surrounding area is heavily developed, used for agricultural purposes, or subject to heavy fertilization. When either nitrate or nitrite is elevated, testing for bacteria is advised. Excessive levels of these nitrogen compounds in drinking water can cause serious illness and sometimes death in infants less than six months of age. This condition results when nitrate is converted to nitrite in the infant's body. Nitrite then interferes with the oxygen carrying capacity of the blood. Symptoms include shortness of breath and blueness of the skin (methemoglobinemia).

Perchlorate is both a naturally occurring and man-made chemical that is used to produce rocket fuel, fireworks, flares and explosives. Perchlorate can also be present in bleach and in some fertilizers. Perchlorate may have adverse health effects. Certain scientific research indicates that this contaminant can disrupt the thyroid's ability to produce hormones needed for normal growth and development.

Bromine is found in seawater and exists as the bromide ion at a level of about 65 mg/l. Bromide is extensively used in the pharmaceutical industry and has been used in swimming pools and cooling towers for disinfection. The presence of bromide in water to which oxidants, such as ozone, are subsequently added can result in the formation of bromate which can potentially exceed the US EPA MCL of 10 ppb. Ethylene bromide is used as an anti-knock additive in gasoline and methyl bromide is a soil fumigant. Bromine is extremely reactive and corrosive, and will produce irritation and burning to exposed tissues. Concentrations exceeding 0.05 mg/l in fresh water may indicate the presence of industrial wastes, possibly from the use of pesticides or biocides containing bromine Exposure to excessive consumption of fluoride over a lifetime may lead to increased likelihood of bone fractures in adults, and may result in effects on bone leading to pain and tenderness. Children aged 8 years and younger exposed to excessive amounts of fluoride have an increased chance of developing pits in the tooth enamel, along with a range of cosmetic effects to teeth. Hexavalent chromate is regulated in the USA at a maximum of 100 ppb and in California at 50 ppb. Legislation is underway in California to reduce the MCL to possibly 10 ppb. It is therefore an object of the invention to remove any harmful anionic contaminants from water.

In addition to industrial anionic contamination, potentially health damaging anionic contaminants that are naturally found in water, such as sulfate (SO₄²⁻) are also included in the scope of the invention. Health concerns regarding sulfate in drinking water have been raised because of reports that diarrhea may be associated with the ingestion of water containing high levels of sulfate. Of particular concern are groups within the general population that may be at greater risk from the laxative effects of sulfate when they experience an abrupt change from drinking water with low sulfate concentrations to drinking water with high sulfate concentrations. Sulfate in drinking water currently has a secondary maximum contaminant level (SMCL) of 250 milligrams per liter (mg/L), based on aesthetic effects (i.e., taste and odor). This regulation is not a federally enforceable standard, but is provided as a guideline for states and public water systems. EPA estimates that about 3% of the public drinking water systems in the country may have sulfate levels of 250 mg/L or greater.

Other non-limiting examples of contaminants include nitrate, arsenic, chromate, selenate, uranium, fluoride, bromide, sulfate, chloride or organic contaminants, or combinations thereof.

In some embodiments, the contaminant is present in the feed water in an amount of about 1 ppm or greater, or about 2, 3, 4, 5, 6, 7, 8, 9, or 10 ppm or greater. In some embodiments, the contaminant is present in an amount of 1-10, or 2-15, or 10-30 ppm or greater. In some embodiments, the contaminant is present in an amount of about 1000 ppm. In some embodiments the contaminant is present in the feed water in an amount of about 100 ppm, or 125, 150, 160, 170, 180, 190, or about 200 ppm. In some embodiments, the feed water has an anionic concentration (e.g., nitrate concentration) up to about 1000 ppm. In other embodiments, the feed water has an anionic concentration (e.g., nitrate concentration) of up to about 160 ppm. In some preferred embodiments, the feed water has an anionic concentration (e.g., nitrate concentration) of about 10 to 50 ppm, or about 1 to about 10, or about 10 to about 225 ppm. In some preferred embodiments, the feed water has an ionic concentration (e.g., nitrate concentration) of about 10 to 50 ppm, or about 1 to about 10, or about 10 to about 225 ppm.

In some embodiments, the contaminants in the feed water comprise organic contaminants. In some embodiments, the concentration of organic contaminants in the feed water, expressed as total organic carbon (TOC), is in the range of about 0.5 to about 20 ppm, or about 3 to about 8 ppm.

In some embodiments, the contaminants in the feed water comprise arsenic contaminants. In some embodiments, the concentration of arsenic contaminants in the feed water is in the range of about 5 to about 500 ppb. In some embodiments, the concentration of arsenic contaminants in the feed water is in the range of about 5 to about 25 ppb. In some embodiments, the concentration of arsenic contaminants in the feed water is about 10 ppb.

In some embodiments, the contaminants in the feed water comprise chromate contaminants. In some embodiments, the concentration of chromate contaminants in the feed water is in the range of about 2 to about 200 ppb. In some embodiments, the concentration of chromate contaminants in the feed water is in the range of about 10 to about 60 ppb. In some embodiments, the concentration of chromate contaminants in the feed water is about 100 ppb.

In some embodiments, the contaminants in the feed water comprise uranium contaminants. In some embodiments, the concentration of uranium contaminants in the feed water is about 5 to about 100 ppb. In some embodiments, the concentration of uranium contaminants in the feed water is about 25 to about 75 ppb. In some embodiments, the concentration of uranium contaminants in the feed water is about 30 ppb.

In some embodiments, the contaminants in the feed water comprise fluoride contaminants. In some embodiments, the concentration of fluoride contaminants in the feed water is in a range of about 2 to about 8 ppm. In some embodiments, the concentration of fluoride contaminants in the feed water is about 4 ppm.

In some embodiments, the contaminants in the feed water comprise selenate contaminants. In some embodiments, the concentration of selenate contaminants in the feed water is in the range of about 20 to about 100 ppb. In some embodiments, the concentration of selenate contaminants in the feed water is about 50 ppb.

On passing the feed water thorough an ion exchange resin component, the contaminants in the feed water are at least partially reduced. The term “ion exchange resin” is intended to broadly describe polymer resin particles which have been chemically treated to attach or form functional groups which have a capacity for ion exchange. The term “functionalize” refers to processes (e.g. sulfonation, haloalkylation, amination, etc.) for chemically treating polymer resins to attach ion exchange groups, i.e. “functional groups”. The polymer component serves as the substrate or polymeric backbone whereas the functional group serves as the active site capable of exchanging ions with a surrounding fluid medium. The present invention also includes a class of ion exchange resins comprising crosslinked copolymers including interpenetrating polymer networks (IPN). The term “interpenetrating polymer network” is intended to describe a material containing at least two polymers, each in network form wherein at least one of the polymers is synthesized and/or crosslinked in the presence of the other polymer. The polymer networks are physically entangled with each other and in some embodiments may be also be covalently bonded. Characteristically, IPNs swell but do not dissolve in solvent nor flow when heated. Ion exchange resins including IPNs have been commercially available for many years and may be prepared by known techniques involving the preparation of multiple polymer components.

As used herein, the term “polymer component” refers to the polymeric material resulting from a polymerization reaction. For example, in one embodiment of the present invention, the ion exchange resins are “seeded” resins; that is, the resin is formed via a seeded process wherein a polymer seed is first formed and is subsequently treated with monomer and subsequently polymerized. Additional monomer may be subsequently added during the polymerization process. The monomer mixture used during a polymerization step need not be homogeneous; that is, the ratio and type of monomers may be varied. The term “polymer component” is not intended to mean that the resulting resin have any particular morphology. However, the present resins may have a “core-shell” type structure as is described in U.S. Publication No. 2013/0085190, the entire contents of which are incorporated herein by reference. As used herein, the term “core-shell” means that the degree of functionalization (i.e., amination) of the bead changes from the inside (core) to the outside (shell) of the bead. For example, the concentration of chemical functional groups on the core of the bead can be greater than or less than the concentration of functional groups on the shell. In a preferred embodiment of the invention, the concentration of functional groups on the core of the bead is less than the concentration of functional groups on the shell. In another preferred embodiment, the core of the resin is inert, containing no functional groups.

Examples of suitable crosslinking agents include monomers such as polyvinylidene aromatics such as divinylbenzene, divinyltoluene, divinylxylene, divinylnaphthalene, trivinylbenzene, divinyldiphenyl ether, divinyldiphenylsulfone, as well as diverse alkylene diacrylates and alkylene dimethacrylates. Preferred crosslinking monomers are divinylbenzene, trivinylbenzene, and ethylene glycol dimethacrylate. The terms “crosslinking agent,” “crosslinker” and “crosslinking monomer” are used herein as synonyms and are intended to include both a single species of crosslinking agent along with combinations of different types of crosslinking agents.

The polymer particles of the present invention can also be prepared by suspension polymerization or jetting of an organic phase comprising, for example, monovinylidene monomers such as styrene, crosslinking monomers such as divinylbenzene, a free-radical initiator and, optionally, a phase-separating diluent. The polymer may be macroporous or gel-type. The terms “gel-type” and “macroporous” are well-known in the art and generally describe the nature of the copolymer particle porosity. The term “macroporous” as commonly used in the art means that the copolymer has both macropores and mesopores. The terms “microporous,” “gellular,” “gel” and “gel-type” are synonyms that describe polymer particles having pore sizes less than about 20 Angstroms while macroporous polymer particles have both mesopores of from about 20 to about 500 Angstroms and macropores of greater than about 500.

When using an anion-exchange resin, the capacity for removal of anionic contaminants is increased significantly. The term “anion-exchange resin” indicates a resin which is capable of exchanging negatively charged species with the environment. The term “strong base anion exchange resin” refers to an anion exchange resin that comprises positively charged species which are linked to anions such as Cl⁻, Br⁻, F⁻ and OH⁻. The most common positively charged species are quaternary amines and protonated secondary amines. Suitable anion-exchange resins include resins whose matrix is hydrophobic including anion-exchange resins wherein the exchanging groups are weakly basic in macroporous or macrocross-linked. Preferably, the matrix is polystyrene or polyacrylic, gel form, particularly based on polystyrene/divinylbenzene copolymer. Anion exchange resins may include strong base anion exchange resins (SBA), weak base anion exchange resins (WBA) and related anionic functional resins, of either the gelular or macroporous type containing quaternary ammonium functionality (chloride, hydroxide or carbonate forms), dialkylamino or substituted dialkylamino functionality (free base or acid salt form), and aminoalkylphosphonate or iminodiacetate functionality, respectively. In some embodiments, anion exchange resin is a strong base anion exchange resin. In some embodiments, the anion exchange resin is a gel-type resin containing quaternary ammonium functionality. In some embodiments, the resin comprises a polystyrene matrix cross-linked with divinylbenzene. In some embodiments, the resin is a Purolite® A300E resin, a strong base anion exchange resin with a gel type styrene-divinylbenzene copolymer matrix and a Type II functional group comprised of dimethylethanolamine. In other embodiments the resin is Purolite® A600E/9149 resin. This resin may be, for example, a gel-type resin containing quaternary ammonium functionality and a polystyrene matrix cross-linked with divinylbenzene and comprised of an inert core and an ion exchange-functionalized shell, such as Purolite® SSTA63 and Purolite® SSTA64. Other suitable resins include Type I strong base anion exchange resins with gel type styrene-divinylbenzene copolymer matrix with quaternary amine functional groups. Other suitable resins include Type I strong base anion exchange resins with macroporous type styrene-divinylbenzene copolymer matrix with quaternary amine functional groups. Other suitable resins include Type I strong base anion exchange resins with gel type acrylic copolymer matrix with quaternary amine functional groups. Other suitable resins include Type I strong base anion exchange resins with macroporous-type acrylic copolymer matrix with quaternary amine functional groups. Other suitable resins include mixed base anion exchange resins with strong and weak base functionalities.

In other embodiments, the resin is an orthoporous resin. As used herein, the term “orthoporous resin” refers to macroporous copolymers having large pores (typically in the range of 5,000-200,000 angstroms) and a typical breaking weight of at least 175 g/bead, as described in U.S. Pat. No. 8,496,121, which is incorporated herein by reference in its entirety.

In some embodiments, the resin is an anion exchange resin containing at least two or more functional distinct polymer resin particles in the same vessel, wherein the at least two functionally distinct polymer resin particles contain different anion exchange functional groups. In some embodiments, the anion exchange resin for use in the invention contains 2, 3, 4, 5, 6, 7, or 8 different resins. In a preferred embodiment, the anion exchange resin of the invention comprises 2 or 3 functionally distinct resins. Preferred combination of resins includes a Type II strong base anion resin, such as Purolite A300E or Purolite A510, and an acrylic strong base anion resin, such as gel type Purolite A850 or macroporous type Purolite A860. Another preferred combination of resins includes a nitrate selective resin, such as Purolite A520E, and an acrylic strong base anion resin, such as Purolite A860. Another preferred combination of resins includes a core-shell type strong base anion resin, such as Purolite SSTA63 or Purolite SSTA64, and an orthoporous strong base anion resin, such as Purolite A500U/2788, Purolite NRW5070 and Purolite D5069. A preferred combination of resins includes the proprietary strong base anion resins and colloidal scavenger resins as contained in Purolite TANEX or Purolite MPR1000. Another preferred combination of resins includes a high capacity strong base anion resin, such as Purolite A600E/9149, a macroporous strong anion resin such as Purolite A502Plus, and an orthoporous strong base anion resin, such as Purolite A500U/2788.

Cation-exchange resins may also be used to remove ionic contaminants from the feed water. The term “cation exchange resin” indicates a resin which is capable of exchanging positively charged species with the environment. Cation-exchange resins typically comprise negatively charged species which are linked to cations such as Na⁺, K⁺, Ca²⁺, Mg²⁺, Fe³⁺ or H. The most common negatively charged species are carboxylic, sulfonic and phosphonic acid groups. In some embodiments, the cation-exchange resin is a strong acid cation resin or “SAC” resin. In some embodiments, the SAC resins can be used to remove calcium, magnesium, ammonium, barium, strontium, and radium from water. Such resins can be regenerated with a variety of regenerants, including but not limited to, KCl, KNO₃, NH₄Cl, HNO₃, MgCl₂, MgNO₃, CaCl₂, and CaNO₃.

Periodically, it is necessary to regenerate the resin component to remove the contaminants retained on the resin. Such regeneration requires a regenerant solution capable of displacing anionic and other contaminant compounds from the ionic exchange resin. To reduce the anionic contaminants in feed water, methods in the prior art typically require a liquid brine regenerant solution which is usually made up onsite from dry sodium chloride purchased either in the form of rock or solar salt. The accepted practice is to use large quantities of sodium chloride at an 8 to 10% concentration and at a typical dosage of 8 equivalents of brine to remove one equivalent of anion (e.g., nitrate) from the resin. Under conventional methods, the anionic contaminants from the spent brine cannot be reused as a fertilizer since the large excess of sodium chloride in the brine is detrimental to plant growth. However, it has been surprisingly discovered that very dilute liquid solutions of fertilizers (e.g., ammonium sulfate salts) are capable of eluting a significant amount of the anionic contaminants and other types of contaminants from anionic exchange resins, allowing for repeated service use of the resin and minimum depreciation in anionic removal performance. The fertilizer regenerant does not require the high brine concentrations needed for conventional regenerant solutions. Without being bound by any theory of invention, it is believed that by operating the resin using a relatively dilute concentration of regenerant, superior chemical efficiency can be achieved. For example, at ionic concentrations typical of drinking water (e.g. about 5 meq/l total anions), SBA resins have high selectivity for sulfate. For example, the affinity of the strong base anion resins for sulfate over chloride at 5 meq/L of total anions as measured by separation factors typically range from ratios of 10:1 to 23:1. However, as the ionic concentration increases (as with the 10% concentration used for sodium chloride regeneration), selectivity of the resin for sulfate reverses dramatically such that the separation factors for sulfate decreases to about 1/10 of these values, making it very difficult for the resins to retain sulfate. Despite this, the inventor has surprisingly discovered that efficient regenerant usage can be achieved by using regenerants at comparatively very dilute concentrations (e.g., approaching that of the ionic content of the feedwater).

Fertilizers of the invention may be classified as either organic fertilizers or inorganic fertilizers. As used herein, the term “organic” includes having a molecular skeleton comprising a carbon backbone, such as in compositions derived from living matter. Organic fertilizers are made from materials derived from living things. Animal manures, compost, bonemeal, feather meal, and blood meal are examples of common organic fertilizers. Inorganic fertilizers, on the other hand, are manufactured from non-living materials and include, for example, ammonium nitrate, ammonium sulfate, urea, potassium chloride, potassium sulfate, potash, ammonium phosphate, anhydrous ammonia, potassium nitrate, sodium nitrate, potassium carbonate, ammonium carbonate, ammonium chloride, magnesium sulfate, potassium ammonium sulfate, potassium magnesium sulfate and other phosphate salts, and the like. In some embodiments the term “inorganic fertilizer” excludes sodium chloride.

Organic fertilizers are typically not immediately available to plants and require soil microorganisms to break the fertilizer components down into simpler structures prior to use by the plants. This break-down occurs over a time period and may provide for slower release of nutrients. Organic fertilizers usually have a low salt index, so larger amounts must be applied separately. In addition, the cost of organic fertilizers, on a unit cost of nutrients basis, is typically higher than the inorganic counterparts making the commercial application of conventional organic fertilizers cost prohibitive. In addition, organic fertilizers may not only elicit a plant growth response as observed with common inorganic fertilizers.

Inorganic fertilizers, on the other hand, are readily commercially available and contain nutrients in soluble form that are immediately available to the plant. In general, the term “fertilizer” means any compound which provides nutrients beneficial for plant growth. For example, the fertilizer mentioned herein can include any inorganic salt that improves the sodium adsorption ratio (SAR) of the water and soil to enhance plant growth (e.g. salts of calcium and magnesium where the SAR is calculated as [Na⁺]/{([Ca⁺⁺]+[Mg⁺⁺])/2}^{̂0.5}. As another example, the fertilizer mentioned herein can include any organic compound that improves the water retention ability of the soil to enhance plant growth (e.g., humic and fulvic acids). Inorganic fertilizers are generally inexpensive, having a low unit cost for the desired element. In addition, the exact amount of a given element may be calculated and administered to the plant or soil. Accordingly, in a preferred embodiment of the invention, the fertilizer is an inorganic fertilizer. In other preferred embodiments, the inorganic fertilizer comprises ammonium sulfate. In other preferred embodiments, the inorganic fertilizer comprises potassium sulfate. In other preferred embodiments, the inorganic fertilizer comprises potassium chloride. In other preferred embodiments, the inorganic fertilizer comprises potassium carbonate. In other preferred embodiments, the inorganic fertilizer comprises ammonium chloride. In other preferred embodiments, the inorganic fertilizer comprises ammonium carbonate.

In some embodiments, the fertilizer includes magnesium sulfate (MgSO₄), potassium sulfate (K₂SO₄), ammonium sulfate ((NH₄)₂SO₄), magnesium bisulfate (MgHSO₄), potassium bisulfate (KHSO₄), ammonium bisulfate (NH₄HSO₃), magnesium carbonate (MgCO₃), potassium carbonate (K₂CO₃), ammonium carbonate ((NH₄)₂CO₃), magnesium bicarbonate (MgHCO₃), potassium bicarbonate (KHCO₃), ammonium bicarbonate, (NH₄HCO₃), potassium chloride (KCl), ammonium chloride (NH₄Cl), calcium chloride (CaCl₂), or magnesium chloride (MgCl₂), or combinations thereof. In some embodiments, the regenerant comprises a plurality of different inorganic fertilizers.

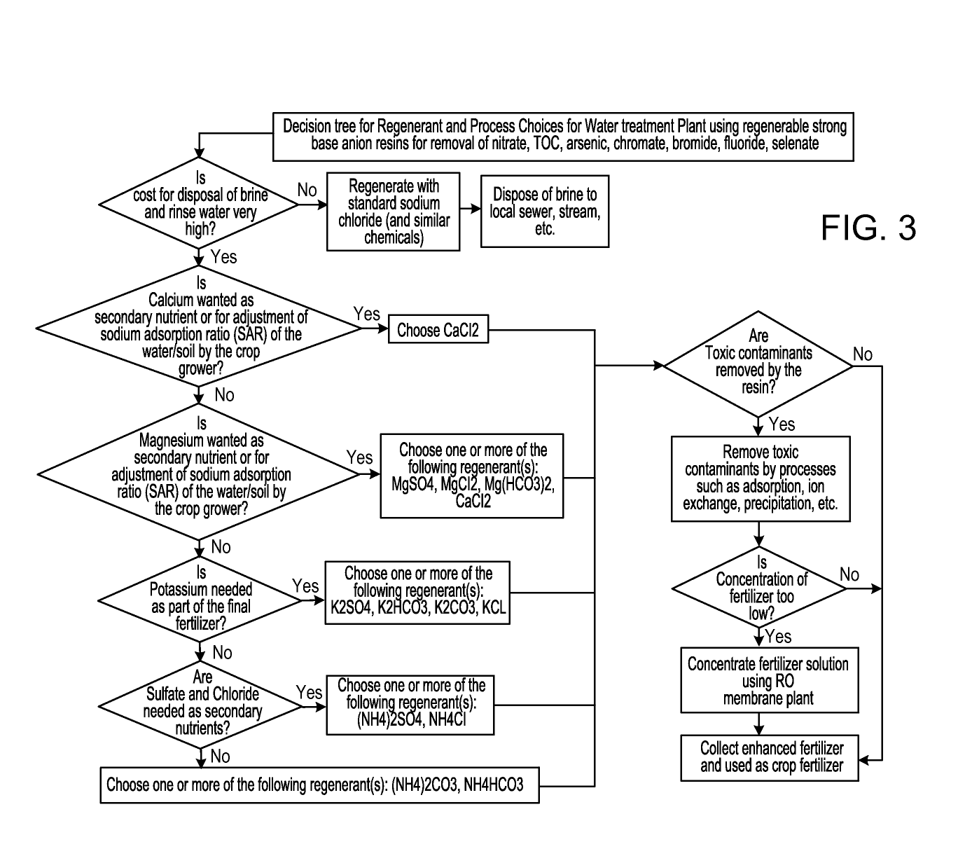

Selection of a particular fertilizer composition for regeneration will depend, in part, on the intended application of the fertilizer for agricultural use. For example, as depicted in FIG. 3, to obtain fertilizer solutions which contain calcium as a secondary nutrient or for the adjustment of sodium adsorption ratio of the water/soil by the crop grower, regenerant solutions containing CaCl₂ are preferably used. Fertilizers containing magnesium as a secondary nutrient or for adjustment of the sodium adsorption ratio of water/soil can be obtained when MgSO₄, MgCl₂, MgHCO₃, or CaCl₂ are used in the regenerant solution. When a fertilizer containing potassium is desired, the regenerant solutions comprising K₂SO₄, K₂HCO₃, K₂CO₃, or KCl can be used. Fertilizers containing sulfate and chloride can be obtained when the regenerant solution contains (NH₄)₂SO₄ or NH₄Cl. In some embodiments, regenerant solutions containing one or more of (NH₄)₂CO₃ or NH₄HCO₃ are also within the scope of the present invention. In some embodiments, nitrate fertilizers devoid of magnesium or potassium can be obtained when ammonium salts are used as the regenerant. In some embodiments, the regenerant fertilizer solution comprises calcium chloride (CaCl₂). In some embodiments, the regenerant comprises calcium chloride (CaCl₂) and the resulting fertilizer solution retrieved from the resin comprises calcium salts. In some embodiments, the regenerant includes a salt selected from magnesium sulfate (MgSO₄), magnesium chloride (MgCl₂), magnesium bicarbonate (MgHCO₃) and calcium chloride, and combinations thereof. In some embodiments, the regenerant includes a salt selected from magnesium sulfate (MgSO₄), magnesium chloride (MgCl₂), magnesium bicarbonate (MgHCO₃) and calcium chloride, and combinations thereof and the resulting fertilizer solution retrieved from the resin comprises magnesium salts. In some embodiments, the regenerant includes a salt selected from potassium sulfate (K₂SO₄), potassium bicarbonate (KHCO₃), potassium carbonate (K₂CO₃), and potassium chloride (KCl), and combinations thereof. In some embodiments, the regenerant includes a salt selected from potassium sulfate (K₂SO₄), potassium bicarbonate (KHCO₃), potassium carbonate (K₂CO₃), and potassium chloride (KCl), and combinations thereof and the resulting fertilizer solution retrieved from the resin comprises potassium salts. In some embodiments, the regenerant comprises ammonium sulfate ((NH₄)₂SO₄) or ammonium chloride (NH₄Cl). In some embodiments, the regenerant comprises ammonium sulfate ((NH₄)₂SO₄) or ammonium chloride (NH₄Cl) and the resulting fertilizer solution retrieved from the resin comprises sulfate or chloride. In some embodiments, the regenerant comprises potassium ammonium sulfate (KNH₄SO₄) and potassium ammonium carbonate (KNH₄CO₃), and the resulting fertilizer solution retrieved from the resin comprises potassium, ammonium, sulfate and carbonate. In some embodiments, the regenerant comprises potassium magnesium sulfate (K₂Mg(SO₄)₂) and ammonium carbonate ((NH₄)₂CO₃), and the resulting fertilizer solution retrieved from the resin comprises potassium, magnesium, ammonium, sulfate and carbonate. In some embodiments ammonium hydroxide (NH₄OH) is excluded from the fertilizer solution.

In some embodiments, the concentration of inorganic fertilizer is from about 0.001 to 5 weight %, or at least about 0.001, 0.002, 0.003, 0.004, 0.005, 0.006, 0.007, 0.008, 0.009, 0.01, 0.2, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 20, 2.1, 2.2, 2.3, 2.4, or about 2.5 weight % and/or at most about 5 weight %. In some embodiments, the concentration of inorganic fertilizer is from about 0.001 to about 2.5 weight %. In some embodiments, the concentration of inorganic fertilizer is about 1 weight %. In some embodiments, the concentration of ammonium or potassium salts in the inorganic fertilizer is from about 0.001 to about 2.5 weight %. In some embodiments, the concentration of ammonium or potassium salts in the inorganic fertilizer is from about 0.001 to about 2.5 weight %. In some embodiments, the concentration of ammonium or potassium salts in the inorganic fertilizer is about 1 weight %. In some embodiments, the concentration of the inorganic fertilizer is about 5 weight % or about 10% or about 20%, or about 25 weight %, or about 50% weight %. In some embodiments, the concentration of ammonium or potassium salts in the inorganic fertilizer is about 5 weight % or about 10%, or about 20%, or about 25 weight %, or about 50 weight %. In some embodiments, the concentration of inorganic salts in the fertilizer solution retrieved from the resin (or the “enhanced” fertilizer) is higher than the concentration of inorganic salts in the regenerant.

In addition to the fertilizer component, the regenerant can optionally comprise one or more chloride salts such as potassium, calcium, or ammonium chloride, or an alkali or base, such as caustic potash, ammonium carbonate and sesquicarbonates of sodium or potassium. In another embodiment, the regenerant optionally comprises a chloride brine solution (e.g. sodium chloride).

In some embodiments, the regenerant solution can comprise a solution of potassium chloride (or brine). In one embodiment, the regenerant solution is an aqueous potassium chloride solution comprising less than or equal to about 20%, 10%, 5%, 1 or less than or equal to about 0.5% potassium chloride (or about 0.5% or less than about 0.5%, 0.4%, 0.3%, or 0.25% potassium chloride).

In some embodiments, the regenerant solution optionally comprises about 5% sodium chloride, or about 4.5, 4.0, 3.5, 3.0, 2.5, 2.0, 1.5, 1.0, 0.5, 0.4, 0.3, 0.25, 0.2, 0.125% sodium chloride. In some embodiments, the regenerant solution comprises about 0.5% sodium chloride. In some embodiments, the regenerant solution comprises less than 0.5% sodium chloride or less than about 0.4, 0.3, 0.25, 0.2, 0.125% sodium chloride.

In some embodiments, the regenerant solution is warmed before treating the resin. In some embodiments, the regenerant is warmed up to about 95 to about 140° F. In some embodiments the regenerant solution is added to the resin at room temperature.

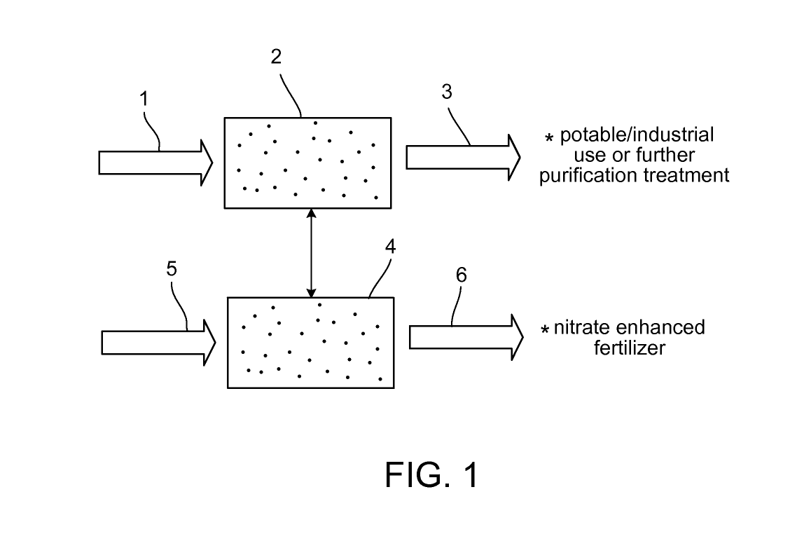

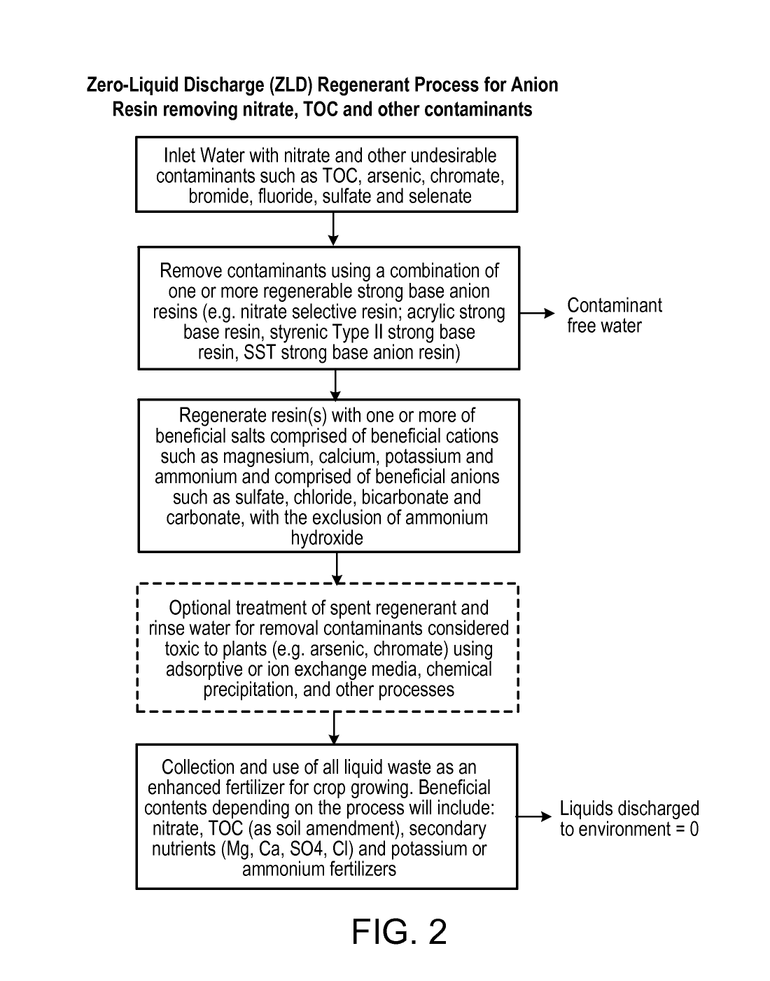

FIG. 1 illustrates a basic embodiment of a water treatment system, or a stage of a water treatment system, of the present invention. A source water 1, which may be a contaminated ground water, a waste stream containing contaminant or a pretreated or intermediate product or waste stream of a treatment plant, is passed through an anion exchange material 2 to selectively remove contaminants and produces a treated stream 3 of lesser contaminant concentration. As further shown in FIG. 1, the resin may be rotated out of service 4, and may be cleaned or regenerated by a fertilizer solution 5 and/or suitable rinses to remove all or a substantial portion of the captured contaminants and return the resin to a regenerated or active ion exchange state 2. The waste stream 6 from the out of service resin 4 can be isolated as an enhanced fertilizer solution. Another embodiment of the invention is illustrated in FIG. 2. Regeneration may be performed continuously on a portion of the resin removed from the vessel for the filtration step while filtration continues with the remainder of the resin followed by recycling of the regenerated resin. Alternatively, regeneration may be performed during periodic shutdown of the resin bed. In some embodiments, at least one pair of ion exchange columns are loaded with the same volumes of resin with one ion exchange column in service removing the contaminants from the feed water while the other column is off-line and being regenerated with the inorganic fertilizer.

In some embodiments, the enhanced fertilizer solution is further treated to remove any toxic contaminants collected from the resin. In this embodiment, the toxic contaminants may be removed using conventional methods, for example, by adsorption ion exchange, precipitation, and the like. In other embodiments, if the concentration of the enhanced fertilizer solution collected from the resin is too low, the fertilizer can be concentrated further using, for example, a reverse osmosis membrane plant.

In some embodiments, the fertilizer solution isolated from the resin also comprises rinse water used to rinse the resin after the regeneration step.

In a preferred embodiment, the quality of the fertilizer used as the regenerant is classified as food grade or superior, being especially applicable for resins treating water intended for human consumption.

In some embodiments, removal of multiple contaminants from the feed water can be achieved at the same time. In this embodiment, multiple contaminants (e.g., nitrate, TOC, arsenic) are removed at the same time using a combination of anion resins in a single ion exchange vessel, either mixed or layered (e.g., the resins can be styrenic, acrylic, nitrate selective or Type II). In this embodiment, potassium, magnesium, or ammonium regenerants may be used to regenerate the resin. Toxic contaminants such as arsenic may be removed using an additional step that removes the contaminant before the combined regenerant is used as a fertilizer.

In one embodiment, multiple contaminants (e.g. uranium, nitrate, arsenic, chromate, TOC) are removed using a combination of resins placed in separate vessels, and using a combination of regenerants, with the spent regenerant and rinse water collected and combined as an enhanced fertilizer solution.

Conventional processing conditions, such as the frequency of regeneration, concentration of the regenerant streams and ratio of regenerant to feed water, may vary to a significant extent depending upon the type of feed water to be processed. The invention allows for one or more fertilizers to be used, depending on the desired ratio of fertilizer components needed in the final regenerant solution. After a volume of water is passed through an anion exchange resin, a liquid volume of one or more fertilizers is used to elute the anionic, organic and other contaminants loaded on the resin. The anions stripped from the resins are replaced by the anionic component (or components) of the fertilizer(s), allowing reuse of the resin for subsequent water treatment.

On passage of the fertilizer through the resin contaminants are displaced. The resins can either be operated in co-flow mode, with the water and fertilizer entering and exiting the ion exchange vessel in the same direction, or in counter-flow mode, with water and fertilizer entering the vessel in opposite directions. In a preferred embodiment, counter-flow is preferred as the freshest regenerant makes first contact with the volume of resin at the end of the vessel from which the feed water exits when the vessel is next placed into service. This means that the resin where the fertilizer enters gets maximum regeneration efficiency and residual contaminants left over in the resin will be at a minimum. When the resin is put into service, the water leaving the resin makes last contact with this highly regenerated resin and thus desorption of contaminants (i.e. leakage) into the water during the next service cycle is kept to a minimum. Counter-flow operation can therefore use a lower dosage of regenerant compared to co-flow operation.

In some embodiments, the regeneration step reduces the contaminants bound to the resin by at least 20% or more. In some embodiments, the regeneration step reduces the contaminants bound to the resin by at least 1, 2, 3, 4, 5, 6, 7, 8, 9, 10, or 20% or more. In some embodiments, the regeneration reduces a concentration of anions bound to the resin by at least about 20% or more. In some embodiments, the regeneration reduces a concentration of anions bound to the resin by at least about 40% or more. In some embodiments, the regeneration reduces a concentration of anions bound to the resin by at least about 80% or more. In some embodiments, the regeneration reduces a concentration of anions bound to the resin by at least about 85% or more. In some embodiments, the regeneration reduces a concentration of anions bound to the resin by at least about 90% or more. In some embodiments the contaminants bound to the resin is reduced by at least 2-5, 5-10, 7-15, 15-30, or 40% or more. In some embodiments, the contaminants bound to the resin are reduced by at least 80, 85, 90, or 95% or more during the regeneration step.

In some embodiments, the inventive method reduces the contaminants of the feed water by at least 20% or more. In some embodiments, the purification process reduces the contaminants of the feed water by at least 10, 20, 25, 30, 50, 75, or 95% or more. In some embodiments, the purification process reduces the concentration of anions in the feed water by at least about 20% or more. In some embodiments, purification process reduces the concentration of anions in the feed water by at least about 50% or more. In some embodiments, the purification process reduces the concentration of anions in the feed water by at least about 95% or more. In other embodiments the anionic content of the water is reduced to 0.5-2 ppm, or 1, 2, 3, 4, 5, ppm.

In some embodiments, the process is used for the preparation of an enhanced fertilizer composition. In this embodiment, the process comprises: providing a feed water comprising contaminants; passing a volume of the feed water containing contaminants through an anion exchange resin to capture contaminants on the resin; periodically regenerating the resin by passing a volume of a regenerant fertilizer solution including one or more inorganic salts through the resin to release contaminants from the resin into the regenerant fertilizer solution; and isolating the regenerant from the resin to provide an enhanced fertilizer solution.

The isolated regenerant from the resin can be used as an enhanced fertilizer. The fertilizer may be used as fertilizer for commercial crops, such as, for example, fruits, vegetables, grains, grasses, for example turf grasses, and other horticultural and agricultural products. The isolated spent regenerant can also be used for hydroponics and drip irrigation crop systems.

### DEFINITIONS

Unless defined otherwise, all technical and scientific terms used herein generally have the same meaning as commonly understood by one of ordinary skill in the art to which this invention belongs. Generally, the nomenclatures used herein are those well-known and commonly employed in the art. The techniques and procedures are generally performed according to conventional methods in the art and various general references. The nomenclature used herein and the procedures in water purification and polymer chemistry described herein are those well-known and commonly employed in the art.

As used herein, the term “counter-flow,” when used for resin regeneration means that the water being treated by the resin and the fertilizer used for regeneration of the resin enters and leaves the ion exchange apparatus in opposite directions.

As used herein, the term “co-flow,” when used for resin regeneration, means that the water being treated by the resin and the fertilizer used for regeneration of the resin enter and leave the ion exchange apparatus in the same direction.

The term “about” or “approximately” means within an acceptable error range for the particular value as determined by one of ordinary skill in the art, which will depend in part on how the value is measured or determined—e.g., the limitations of the measurement system, or the degree of precision required for a particular purpose. For example, “about” can mean within 1 or more than 1 standard deviations, as per the practice in the art. Alternatively, “about” can mean a range of up to 20%, preferably up to 10%, more preferably up to 5%, and more preferably still up to 1% of a given value. Where particular values are described in the application and claims, unless otherwise stated, the term “about” meaning within an acceptable error range for the particular value should be assumed.

As used herein and in the appended claims, the singular forms “a,” “an,” and “the,” include plural referents unless the context clearly indicates otherwise. Thus, for example, reference to “a molecule” includes one or more of such molecules, “a resin” includes one or more of such different resins and reference to “the method” includes reference to equivalent steps and methods known to those of ordinary skill in the art that could be modified or substituted for the methods described herein.

All U.S. patents and published applications and other publications cited herein are hereby incorporated by reference in their entirety.

### EXAMPLES

### Example 1

### Regeneration of Purolite® A300E Resin with 10% NaCl Brine (Conventional Method)

Data collection for this example was evaluated using Purolite's proprietary IX-SIMULATOR ion exchange simulation software.

Purolite® A300E resin (Type II SBA resin) in chloride form (total capacity 1400 meq/L) (1 L) was loaded onto a 1 cm diameter glass column and used to treat an influent water composition with components shown in Table 1.

TABLE 1
Influent Water Composition

| | Cation | | Anion |
|---|---|---|---|
| | Concentration | | Concentration |
| Cation | (meq/L) | Anion | (meq/L) |
| Calcium | 1 | Sulfate | 1 |
| Magnesium | 1 | Nitrate | 1 |
| Sodium | 3 | Bicarbonate | 2 |
| | | Chloride | 1 |

The influent water (200 BV; 200 L) was passed down-flow through the resin at a flow rate of 20 BV/h. The entire volume of effluent from the column was collected as a composite sample and analyzed for changes in the anionic composition of the water. The components of the resulting composition for each ion in the effluent and loaded on the resin are shown in Table 2.

TABLE 2
Composition of Water and Resin after Loading

| | | | Ions on | |
|---|---|---|---|---|
| | Ions in | | resin | |
| | 200 BV of | | initially | |
| | Influent | Ions in | before | Ions on Resin |
| | water | Effluent | loading | after loading |
| Anion | (meq) | (meq) | (meq) | (meq) |
| Sulfate | 200 | 0 | 0 | 200 |
| Nitrate | 200 | 0 | 0 | 200 |
| Bicarbonate | 400 | 198 | 0 | 202 |
| Chloride | 200 | 802 | 1400 | 798 |

For the regeneration step, sodium chloride solution (10%; 1.1 BV) was passed down-flow through the resin column at a flow rate of 2 BV/h (corresponding to a conventional salt dosage of 2 chemical equivalents per liter of resin, or 120 g/liter of resin, or 7.5 lbs/ft³ of resin). Demineralized water (5 BV) was then added to rinse the resin at the flow rate of 2 BV/h. The effluent from the column was collected as a composite and analyzed for anions by Ion Chromatography using a Dionex Model ICS-2100 IRF System.

The components of the resulting composition of the resin and spent regenerant/rinse water are shown in Tables 3 and 4.

TABLE 3
Loading on Resin

| | | | Ions in | Ions left on |
|---|---|---|---|---|
| | Ions in | Ions on | effluent | the resin |
| | 1.1 BV of | resin before | from | after |
| | Regenerant | regeneration | regeneration | regeneration |
| Anion | (meq) | (meq) | (meq) | (meq) |
| Sulfate | 0 | 200 | 200 | 0 |
| Nitrate | 0 | 200 | 181 | 19 |
| Bicarbonate | 0 | 202 | 202 | 0 |
| Chloride | 2000 | 798 | 1417 | 1381 |

TABLE 4
Final Composition of Spent Regenerant

| | Ion in | |
|---|---|---|
| | Effluent | |
| Ion | (meq) | Total Percent |
| Sodium Sulfate | 200 | 10% |
| Sodium Nitrate | 181 | 9% |
| Sodium Bicarbonate | 202 | 10% |
| Sodium Chloride | 1417 | 71% |

The meq of ions loaded on the resin column after the regeneration step was calculated as follows: 0 meq sulfate, 19 meq nitrate, 0 meq bicarbonate, and 1381 meq chloride. The above data demonstrates properly regenerating the resin using 2 chemical equivalents of sodium chloride. However, a large excess of 2000 meq of chloride to 181 meq of nitrate (ratio of 11 to 1) was required for the regeneration. The large excess of sodium and chloride makes this effluent solution unsuitable for subsequent use in the fertilization of the vast majority of crops that are not resistant to sodium and chloride. In areas prohibiting the local disposal of such high strength brines, such brine would usually have to be hauled long distances away for final disposal.

### Example 2

### Regeneration of Purolite® A300E Resin with Magnesium Sulfate (Inventive Method)

In this example, the superior chemical efficiency achieved with the inventive method is demonstrated. This example also provides a fertilizer composition with enhanced nitrogen content. Data collection for this example was evaluated using Purolite's proprietary IX-SIMULATOR ion exchange simulation software.

Purolite® A300E resin (Type II SBA resin) in the sulfate form (total capacity 1400 meq/L) (1 L) was loaded onto a 1 cm diameter glass column and used to treat an influent water composition with components shown in Table 1 (above).

The influent water (200 BV; 200 L) was passed down-flow through the resin at a flow rate of 20 BV/h. The entire volume of effluent from the column was collected as a composite sample and analyzed for changes in the anionic composition of the water. The components of the resulting composition for each ion in the effluent and loaded on the resin are shown in Table 5.

TABLE 5
Composition of Water and Resin After Treatment

| | | | Ions on | |
|---|---|---|---|---|
| | Ions in | | resin | |
| | 200 BV of | | initially | |
| | Influent | Ions in | before | Ions on Resin |
| | water | Effluent | loading | after loading |
| Anion | (meq) | (meq) | (meq) | (meq) |
| Sulfate | 200 | 421 | 1400 | 1179 |
| Nitrate | 200 | 55 | 0 | 145 |
| Bicarbonate | 400 | 375 | 0 | 25 |
| Chloride | 200 | 149 | 0 | 51 |

For the regeneration step, magnesium sulfate solution (approximately 1.3%; 4.67 BV) (corresponding to a concentration of 0.2 eq/L or a total of 0.934 chemical equivalents per liter of resin), was passed down-flow through the resin column at a flow rate of 2 BV/h. Demineralized water (5 BV) was then added to rinse the resin at a flow rate of 2 BV/h. The effluent from the column was collected as a composite and the ionic composition determined. The components of the resulting composition of the spent regenerant and rinse water and meq left on the resin after regenerations were determined as shown in Tables 6 and 7.

TABLE 6
Loading on Resin

| | | | Ions in | Ions left on |
|---|---|---|---|---|
| | Ions in | Ions on | effluent | the resin |
| | 4.67 BV of | resin before | from | after |
| | Regenerant | regeneration | regeneration | regeneration |
| Anion | (meq) | (meq) | (meq) | (meq) |
| Sulfate | 934 | 1179 | 728 | 1385 |
| Nitrate | 0 | 145 | 134 | 11 |
| Bicarbonate | 0 | 25 | 23 | 2 |
| Chloride | 0 | 51 | 49 | 2 |

TABLE 7
Final Composition of Spent Regenerant

| | Ion in | |
|---|---|---|
| | Effluent | |
| Ion | (meq) | Percent |
| Magnesium Sulfate | 728 | 77.9% |
| Magnesium Nitrate | 134 | 14.3% |
| Magnesium Bicarbonate | 23 | 2.5% |
| Magnesium Chloride | 49 | 5.2% |

The meq of ions loaded on the resin column was calculated as follows: 1385 meq sulfate, 11 meq nitrate, 2 meq bicarbonate, and 2 meq chloride. The above data demonstrates that the ion exchange resin had been efficiently regenerated with the removal of over 92% of the nitrate previously loaded. In particular, all of the magnesium component of the fertilizer was recovered since it was not exchanged onto the resin and would be suitable for use as a secondary nutrient for crops. A total of 56.2 grams of magnesium sulfate was used for the regeneration. The final content of the effluent was a mixture of magnesium salts as shown in Table 7, amounting to 57.79 grams of which 8.3 grams of beneficial nitrogen had been added to the fertilizer. Accordingly, the output of nitrogen using the inventive method provides a fertilizer with higher nitrogen content and higher economic value.

The data shown in Table 8 compares the regeneration efficiency between the magnesium sulfate and sodium chloride regeneration methods.

TABLE 8
Regeneration Efficiency of Magnesium Sulfate

| | Dosage | | | |
|---|---|---|---|---|
| | (meq | Nitrate | | Percent |
| | Regenerant | Eluted | Regenerant | reduction in |
| | per | (meq NO₃/L | (meq)/Nitrate | regenerant |
| Regenerant | liter of resin) | resin | (meq) | usage |
| Sodium | 2000 | 181 | 11 to 1 | — |
| Chloride | | | | |
| Magnesium | 934 | 134 | 6.98 to 1 | 37% |
| Sulfate | | | | |

As shown in Table 8, a 37% reduction in regenerant usage was achieved using a magnesium sulfate fertilizer regenerant compared with a conventional sodium chloride regenerant. In the inventive process, about 84% (i.e., 1179 meg/1400 meg≈0.84) of the resin sites were converted to the sulfate form, the same as that of the regenerant used (see Table 5), whereas with the conventional method, only 57% (i.e., 798 meg/1400 meg=0.57) of the sites were converted to the same chloride form as used in the regenerant (see Table 2). Accordingly, a smaller amount of sulfate regenerant is needed to return the inventive resin exchange sites to the regenerated state.

### Example 3

### Regeneration of Purolite® A300E Resin with Potassium Bicarbonate (Inventive Method)

In this example, potassium, one of the three primary nutrients needed for crop fertilization (i.e., nitrogen, phosphorous, and potassium) was used in combination with the bicarbonate form at dilute concentration to produce a spent regenerant that was enriched in nitrogen content. Data collection for this example was evaluated using Purolite's proprietary IX-SIMULATOR ion exchange simulation software.

Purolite® A300E resin (Type II SBA resin) in the bicarbonate form (total capacity 1400 meq/L) (1 L) was loaded onto a 1 cm diameter glass column and used to treat an influent water composition with components shown in Table 1 (above).

The influent water (300 BV; 300 L) was passed down-flow through the resin at a flow rate of 20 BV/h. The entire volume of effluent from the column was collected as a composite sample and analyzed for changes in the anionic composition of the water. The components of the resulting composition for each ion in the effluent and loaded on the resin are shown in Table 9.

TABLE 9
Composition of Water and Resin after Loading

| | | | Ions on | |
|---|---|---|---|---|
| | Ions in | | resin | |
| | 300 BV of | | initially | |
| | Influent | Ions in | before | Ions on Resin |
| | water | Effluent | loading | after loading |
| Anion | (meq) | (meq) | (meq) | (meq) |
| Sulfate | 300 | 0 | 0 | 300 |
| Nitrate | 300 | 17 | 0 | 283 |
| Bicarbonate | 600 | 1421 | 1400 | 579 |
| Chloride | 300 | 62 | 0 | 238 |

For the regeneration step, 6 bed volumes of potassium bicarbonate at a concentration of 0.5 eq/L, (a total of 3 chemical equivalents per liter of resin), was passed down-flow through the resin column at a flow rate of 2 BV/h. Demineralized water (5 BV) was then added to rinse the resin at a flow rate of 2 BV/h. The effluent from the column was collected as a composite and the ionic composition determined. The components of the resulting composition of the spent regenerant and rinse water and meq loaded on the resin after regenerations were determined as shown in Tables 10 and 11.

TABLE 10
Loading on Resin

| | | | Ions in | Ions left on |
|---|---|---|---|---|
| | Ions in | Ions on | effluent | the resin |
| | 6 BV of | resin before | from | after |
| | Regenerant | regeneration | regeneration | regeneration |
| Anion | (meq) | (meq) | (meq) | (meq) |
| Sulfate | 0 | 300 | 291 | 9 |
| Nitrate | 0 | 283 | 275 | 8 |
| Bicarbonate | 3000 | 579 | 2207 | 1372 |
| Chloride | 0 | 238 | 227 | 11 |

TABLE 11
Final Composition of Spent Regenerant

| | Ion in | |
|---|---|---|
| | Effluent | |
| Ion | (meq) | Percent |
| Potassium Sulfate | 291 | 9.7% |
| Potassium Nitrate | 275 | 9.2% |
| Potassium Bicarbonate | 2207 | 73.6% |
| Potassium Chloride | 227 | 7.6% |

The meq of ions loaded on the resin column was calculated as follows: 9 meq sulfate, 8 meq nitrate, 1372 meq bicarbonate and 11 meq chloride. The above data demonstrates that the ion exchange resin had been efficiently regenerated, with 97% of the nitrate removed from the resin. In particular, all of the potassium component of the fertilizer was recovered since it was not exchanged onto the resin and can be used as a nutrient for crops. A total of 300 grams of potassium bicarbonate was used for the regeneration. The final content of the effluent was a mixture of potassium salts as shown in Table 11, amounting to 285 grams of which 4 grams of beneficial nitrogen had been added to the fertilizer. The fertilizer content of the original KHCO₃ chemical had a potassium content of 117 grams, whereas the final regenerant had a potassium content of 117 grams and a nitrogen content of 4 grams. Accordingly, the output of nitrogen using the inventive method provides a fertilizer with higher nitrogen content and higher economic value.

What is claimed is:

1. A method of purifying feed water containing contaminants comprising:
passing a volume of the feed water containing contaminants through an anion exchange resin to capture contaminants on the resin;
periodically regenerating the resin by passing a volume of a regenerant fertilizer solution including one or more inorganic salts through the resin to release contaminants from the resin into the regenerant fertilizer solution;
rinsing the resin of residual regenerant solution by passing a volume of a rinse solution through the resin; and
isolating the regenerant and rinse solution from the resin to provide an enhanced fertilizer solution.

2. The method of claim 1, wherein a concentration of inorganic salts in the enhanced fertilizer solution is higher than a concentration of inorganic salts in the regenerant fertilizer solution.

3. The method of claim 1, wherein the regenerant fertilizer solution includes a salt selected from the group consisting of magnesium sulfate (MgSO₄), potassium sulfate (K₂SO₄), ammonium sulfate ((NH₄)₂SO₄), potassium ammonium sulfate (KNH₄SO₄), potassium magnesium sulfate (K₂Mg(SO₄)₂), magnesium bisulfate (MgHSO₄), potassium bisulfate (KHSO₄), ammonium bisulfate (NH₄HSO₃), magnesium carbonate (MgCO₃), potassium carbonate (K₂CO₃), ammonium carbonate ((NH₄)₂CO₃), magnesium bicarbonate (MgHCO₃), potassium bicarbonate (KHCO₃), ammonium bicarbonate, (NH₄HCO₃), potassium chloride (KCl), ammonium chloride (NH₄Cl), calcium chloride (CaCl₂), and magnesium chloride (MgCl₂), and combinations thereof.

4. The method of claim 1, wherein the regenerant fertilizer solution comprises calcium chloride (CaCl₂).

5. The method of claim 1, wherein the regenerant fertilizer solution comprises calcium chloride (CaCl₂) and the enhanced fertilizer solution comprises calcium salts.

6. The method of claim 1, wherein the regenerant fertilizer solution includes a salt selected from the group consisting of magnesium sulfate (MgSO₄), magnesium chloride (MgCl₂), magnesium bicarbonate (MgHCO₃) and calcium chloride, and combinations thereof.

7. The method of claim 1, wherein the regenerant fertilizer solution includes a salt selected from the group consisting of magnesium sulfate (MgSO₄), magnesium chloride (MgCl₂), magnesium bicarbonate (MgHCO₃) and calcium chloride, and combinations thereof and the enhanced fertilizer solution comprises magnesium salts.

8. The method of claim 1, wherein the regenerant fertilizer solution includes a salt selected from the group consisting of potassium sulfate (K₂SO₄), potassium bicarbonate (KHCO₃), potassium carbonate (K₂CO₃), and potassium chloride (KCl), and combinations thereof.

9. The method of claim 1, wherein the regenerant fertilizer solution includes a salt selected from the group consisting of potassium sulfate (K₂SO₄), potassium bicarbonate (KHCO₃), potassium carbonate (K₂CO₃), and potassium chloride (KCl), and combinations thereof and the enhanced fertilizer solution comprises potassium salts.

10. The method of claim 1, wherein the regenerant fertilizer solution comprises ammonium sulfate ((NH₄)₂SO₄) or ammonium chloride (NH₄Cl).

11. The method of claim 1, wherein the regenerant fertilizer solution comprises ammonium sulfate ((NH₄)₂SO₄) or ammonium chloride (NH₄Cl) and the enhanced fertilizer solution comprises sulfate or chloride.

12. The method of claim 1, wherein the regenerant fertilizer solution comprises magnesium, ammonium or potassium salts.

13. The method of claim 1, wherein the regenerant fertilizer solution comprises ammonium sulfate.

14. The method of claim 1, wherein the regenerant fertilizer solution comprises potassium sulfate.

15. The method of claim 1, wherein the regenerant fertilizer solution comprises a plurality of inorganic fertilizers.

16. The method of claim 1, wherein the concentration of inorganic salts in the regenerant fertilizer solution is from 0.001 to 50 weight %.

17. The method of claim 1, wherein the concentration of inorganic salts in regenerant fertilizer solution is from 0.001 to 2.5 weight %.

18. The method of claim 1, wherein the concentration of inorganic salts in the regenerant fertilizer solution is 1 weight %.

19. The method of claim 1, wherein the feed water is a ground water, surface water, agricultural field drainage, process feed water, or process waste water.

20. The method of claim 1, wherein the contaminants in the feed water include ionic or organic contaminants.

21. The method of claim 1, wherein the contaminants in the feed water are selected from nitrate, arsenic, chromate, selenate, uranium, fluoride, bromide, sulfate, chloride, or organic contaminants, or combinations thereof.

22. The method of claim 1, wherein the contaminants in the feed water comprise nitrate contaminants.

23. The method of claim 22, wherein the concentration of the nitrate contaminants in the feed water does not exceed 1000 ppm.

24. The method of claim 22, wherein the concentration of the nitrate contaminants in the feed water is 10 to 50 ppm.

25. The method of claim 1, wherein the contaminants in the feed water comprise organic contaminants.

26. The method of claim 25, wherein the concentration of organic contaminants in the feed water, expressed as total organic carbon (TOC), is in the range of 0.5 to 20 ppm.

27. The method of claim 25, wherein the concentration of organic contaminants in the feed water, expressed as total organic carbon (TOC), is in the range of 3 to 8 ppm.

28. The method of claim 1, wherein the contaminants in the feed water comprise arsenic contaminants.

29. The method of claim 28, wherein the concentration of arsenic contaminants in the feed water is in the range of 5 to 500 ppb.

30. The method of claim 28, wherein the concentration of arsenic contaminants in the feed water is in the range of 5 to 25 ppb.

31. The method of claim 28, wherein the concentration of arsenic contaminants in the feed water is in the range of 5 to 10 ppb.

32. The method of claim 1, wherein the contaminants in the feed water comprise chromate contaminants.

33. The method of claim 32, wherein the concentration of chromate contaminants in the feed water is in the range of 2 to 200 ppb.

34. The method of claim 32, wherein the concentration of chromate contaminants in the feed water is in the range of 10 to 60 ppb.

35. The method of claim 32, wherein the concentration of chromate contaminants in the feed water is in the range of 50 to 100 ppb.

36. The method of claim 1, wherein the contaminants in the feed water comprise uranium contaminants.

37. The method of claim 36, wherein the concentration of uranium contaminants in the feed water is 5 to 100 ppb.

38. The method of claim 36 wherein the concentration of uranium contaminants in the feed water is 25 to 75 ppb.

39. The method of claim 36, wherein the concentration of uranium contaminants in the feed water is in the range of 25 to 30 ppb.

40. The method of claim 1, wherein the contaminants in the feed water comprise fluoride contaminants.

41. The method of claim 40, wherein the concentration of fluoride contaminants in the feed water is in a range of 2 to 8 ppm.

42. The method of claim 40, wherein the concentration of fluoride contaminants in the feed water is 2 to 4 ppm.

43. The method of claim 1, wherein the contaminants in the feed water comprise selenate contaminants.

44. The method of claim 43, wherein the concentration of selenate contaminants in the feed water is in the range of 20 to 100 ppb.

45. The method of claim 44, wherein the concentration of selenate contaminants in the feed water is 50 ppb.

46. The method of claim 1, wherein the anion exchange resin is a strong base anion exchange resin.

47. The method of claim 46, wherein the anion exchange resin is a gel-type resin containing quaternary ammonium functionality.

48. The method of claim 1, wherein the anion exchange resin is a macroporous-type resin.

49. The method of claim 1, wherein the anion exchange resin is a mixed base resin with strong and weak base functionalities.

50. The method of claim 1, wherein the resin comprises a polystyrene matrix cross-linked with divinylbenzene.

51. The method of claim 1, wherein the resin comprises an acrylic-type strong base resin.

52. The method of claim 1, wherein the resin is in bead form, comprising aminated functional groups and a matrix of a cross-linked polymer containing a core area and a shell area, wherein the concentration of aminated functional groups is lower in the core area relative to the shell area.

53. The method of claim 1, wherein the anion exchange resin comprises at least two or more functionally distinct polymer resin particles, wherein the at least two functionally distinct polymer resin particles contain different anion exchange functional groups.

54. The method of claim 1, wherein the regeneration reduces a concentration of nitrate anions bound to the resin by at least 20%.

55. The method of claim 1, wherein the regeneration reduces a concentration of nitrate anions bound to the resin by at least 40%.

56. The method of claim 1, wherein the regeneration reduces a concentration of nitrate anions bound to the resin by at least 80%.

57. The method of claim 1, wherein the regeneration reduces a concentration of nitrate anions bound to the resin by at least 85%.

58. The method of claim 1, wherein the regeneration reduces a concentration of nitrate anions bound to the resin by at least 90%.

59. The method of claim 1, wherein said purifying reduces a concentration of contaminants in the feed water by at least 20%.

60. The method of claim 1, wherein said purifying reduces a concentration of contaminants in the feed water by at least 50%.

61. The method of claim 1, wherein said purifying reduces a concentration of contaminants in the feed water by at least 95%.

62. The method of claim 1, wherein said regenerating comprises passing the regenerant solution through the resin in the same direction as the feed water.

63. The method of claim 1, wherein said regenerating comprises passing the regenerant through the resin in the opposite direction as the feed water.

64. The method of claim 1, wherein the rinse solution is feed water or purified feed water.

65. A process for preparing an enhanced fertilizer solution comprising:
providing a feed water comprising contaminants;
passing a volume of the feed water containing contaminants through an anion exchange resin to capture contaminants on the resin;
periodically regenerating the resin by passing a volume of a regenerant fertilizer solution including one or more inorganic salts through the resin to release contaminants from the resin into the regenerant fertilizer solution;
rinsing the resin of residual regenerant solution by passing a volume of a rinse solution through the resin; and
isolating the regenerant and rinse solution from the resin to provide an enhanced fertilizer solution.

66. The method of claim 65, wherein the enhanced fertilizer is a crop fertilizer.
